(19) United States
(12) Patent Application Publication
(10) Pub. No.: US 2012/0098991 A1
(43) Pub. Date: Apr. 26, 2012

(54) IMAGE PROCESSING APPARATUS, IMAGE PROCESSING METHOD AND PROGRAM

(76) Inventor: Yoshikuni Nomura, Tokyo (JP)

(21) Appl. No.: 13/271,996

(22) Filed: Oct. 12, 2011

(30) Foreign Application Priority Data
Oct. 21, 2010 (JP) 2010-236176

(51) Int. Cl. H04N 5/228

(52) U.S. Cl. 348/222.1; 348/E05.031

(57) ABSTRACT

Disclosed is an image processing apparatus including: a detecting section which receives a color mosaic image generated by an imaging process of a single chip color imaging device as an input and detects the strength of a high frequency signal in the proximity of a target pixel which is an interpolation process target; a plurality of statistic calculating sections each of which sets a reference region having a different area around the target pixel and calculates an individual statistic based on a pixel value included in the reference region; and an interpolating section which changes a blended state of the plurality of statistics calculated by the plurality of statistic calculating sections according to the strength of the high frequency signal detected by the detecting section and calculates an interpolated pixel value in the position of the target pixel by a blending process of the plurality of statistics.

### BACKGROUND

The present disclosure relates to an image processing apparatus, an image processing method and a program. In particular, the present disclosure relates to an image processing apparatus, an image processing method and a program which perform signal processing for an output of a single chip image device (single chip color image device).

In an imaging process using a solid state imaging device of a single chip as an imaging device (image sensor) of an imaging apparatus, a color filter which transmits a wavelength component of a specific color such as R, G or B corresponding to each pixel is disposed on the imaging device, to perform color imaging. In this method, since only one color (for example, any one of R, G and B) is obtained for each pixel, an image of a mosaic shape is generated according to colors.

An example of the color filter used in the imaging apparatus is illustrated in FIG. 1A. This arrangement is referred to as the Bayer arrangement, which transmits light of a specific wavelength component (R, G or B) in each pixel unit. The Bayer arrangement includes as a minimum unit four pixels of two filters which transmit green (G), one filter which transmits blue (B) and one filter which transmits red (R).

An image obtained through such a filter becomes an image having only color information according to a pattern of the filter such as R, G or B with respect to each pixel. This image is referred to as a so-called mosaic image. In order to generate a color image from this mosaic image, it is necessary to generate color information about all of R, G and B with respect to all the respective pixels.

All color information (for example, all of R, G and B) corresponding to all the pixels can be calculated by performing interpolation using color information obtained from pixels around each pixel, to thereby generate a color image. This interpolation process is referred to as a demosaicing process. That is, the process of generating color information (R, G and B) for all the individual pixel units on the basis of an imaged signal shown in FIG. 1A and obtaining an image signal shown in FIG. 1B is referred to as an interpolation process, a demosaicing process, an up-sampling process, or the like.

For such a color interpolation process (demosaicing process), a variety of techniques such as U.S. Pat. No. 4,642,678 have been proposed.

In particular, a technique in which unclear color is interpolated using a signal in a direction where the correlation is high, as disclosed in U.S. Pat. No. 5,652,621 or Japanese Unexamined Patent Application Publication No. 7-236147, can interpolate even a high frequency component of a signal with high accuracy.

However, in these techniques in the related art, it is difficult to completely interpolate unclear color, and it is highly likely that false color occurs for a color signal including a high frequency component. Here, the false color refers to the phenomenon in which an image is seen as being colored as aliasing occurs in an interpolated color signal.

Further, [K. Hirakawa, T. W. Parks “Adaptive Homogeneity-Directed Demosaicing Algorithm”] discloses a technique in which false color is effectively reduced for a mosaic image imaged using an imaging device of the Bayer arrangement, by finding an interpolation direction where the occurrence of false color is the minimum. However, this technique has problems that suppression of false color is not so completely achieved, and in particular, false color significantly occurs in an arrangement having a large number of colors.

Further, in order to suppress false color, a technique of reducing a high frequency component of a color signal in an optical manner by using a special filter at the time of photography, for example, an optical low pass filter (OLPF), has been proposed. However, in the technique using this kind of filter, since there is no filter (OLPF) having ideal frequency characteristics, it is difficult to sufficiently suppress false color.

### SUMMARY

Accordingly, it is desirable to provide an image processing apparatus, an image processing method and a program which can generate a color image which is a high quality interpolated image obtained by suppressing occurrence of false color in an interpolation process of a mosaic image imaged by a single chip color imaging device.

Further, it is desirable to provide an image processing apparatus, an image processing method and a program which can generate a color image which is a high quality interpolated image obtained by suppressing occurrence of false color, without significant addition of a calculation amount or hardware.

According to an embodiment of the present disclosure, there is provided an image processing apparatus including: a detecting section which receives a color mosaic image generated by an imaging process of a single chip color imaging device as an input and detects the strength of a high frequency signal in the proximity of a target pixel which is an interpolation process target; a plurality of statistic calculating sections each of which sets a reference region having a different area around the target pixel and calculates an individual statistic based on a pixel value included in the reference region; and an interpolating section which changes a blended state of the plurality of statistics calculated by the plurality of statistic calculating sections according to the strength of the high frequency signal detected by the detecting section and calculates an interpolated pixel value in the position of the target pixel by a blending process of the plurality of statistics.

In the above embodiment, the interpolating section may calculate the interpolated pixel value in which a contribution of a statistic calculated on the basis of a broad reference region is set at a high level in a case where the strength of the high frequency signal detected by the detecting section is large, and calculates the interpolated pixel value in which a contribution of a statistic calculated on the basis of a narrow reference region is set at a high level in a case where the strength of the high frequency signal detected by the detecting section is small.

According to another embodiment of the present disclosure, there is an image processing apparatus including: a detecting section which receives a color mosaic image generated by an imaging process of a single chip color imaging device as an input and detects the strength of a high frequency signal in the proximity of a target pixel which is an interpolation process target; a reference region determining section which determines a reference region which defines the range of a reference pixel applied for calculating an interpolated pixel value of the target pixel, the reference region having a different area according to the strength of the high frequency signal detected by the detecting section; a statistic calculating section which calculates a statistic for determining the interpolated pixel value on the basis of a pixel value included in the reference region determined by the reference region determining section; and an interpolating section which calculates the interpolated pixel value in the position of the target pixel on the basis of the statistic calculated by the statistic calculating section.

In the above embodiment, the reference region determining section may set a broad reference region in a case where the strength of the high frequency signal detected by the detecting section is large, and set a narrow reference region in a case where the strength of the high frequency signal detected by the detecting section is small.

In the above embodiment, the detecting section may detect the strength of the high frequency signal in the proximity of a Nyquist frequency, in the proximity of the target pixel which is the interpolation process target.

In the above embodiment, the detecting section may detect the strength of the high frequency signal using a high-pass filter (HPF) which transmits a high frequency band in the proximity of the Nyquist frequency.

In the above embodiment, the detecting section may calculate a color signal included in the color mosaic image generated by the imaging process of the single chip color imaging device and detects the strength of the high frequency signal on the basis of the calculated signal.

In the above embodiment, the statistic calculating section calculates an average of the pixel values of pixels included in the reference region as the statistic.

In the above embodiment, the statistic calculating section employs an IIR (Infinite Impulse Response) filter.

According to still another embodiment of the present disclosure, there is provided an image processing method of performing a pixel value interpolation process in an image processing apparatus, the method including: receiving a color mosaic image generated by an imaging process of a single chip color imaging device as an input and detecting the strength of a high frequency signal in the proximity of a target pixel which is an interpolation process target, by a detecting section; setting a reference region having a different area around the target pixel and calculating an individual statistic based on a pixel value included in the reference region, by each of a plurality of statistic calculating sections; and changing a blended state of the plurality of statistics calculated by the plurality of statistic calculating sections according to the strength of the high frequency signal detected by the detecting section and calculating an interpolated pixel value in the position of the target pixel by a blending process of the plurality of statistics, by an interpolating section.

According to still another embodiment of the present disclosure, there is provided an image processing method of performing a pixel value interpolation process in an image processing apparatus, the method including: receiving a color mosaic image generated by an imaging process of a single chip color imaging device as an input and detecting the strength of a high frequency signal in the proximity of a target pixel which is an interpolation process target, by a detecting section; determining a reference region which defines the range of a reference pixel applied for calculating an interpolated pixel value of the target pixel, the reference region having a different area according to the strength of the high frequency signal detected by the detecting section, by a reference region determining section; calculating a statistic for determining the interpolated pixel value on the basis of a pixel value included in the reference region determined by the reference region determining section, by a statistic calculating section; and calculating the interpolated pixel value in the position of the target pixel on the basis of the statistic calculated by the statistic calculating section, by an interpolating section.

According to still another embodiment of the present disclosure, there is provided a program which causes a pixel value interpolation process to be executed in an image processing apparatus, the program having a routine including: receiving a color mosaic image generated by an imaging process of a single chip color imaging device as an input and detecting the strength of a high frequency signal in the proximity of a target pixel which is an interpolation process target, in a detecting section; setting a reference region having a different area around the target pixel and calculating an individual statistic based on a pixel value included in the reference region, in each of a plurality of statistic calculating sections; and changing a blended state of the plurality of statistics calculated by the plurality of statistic calculating sections according to the strength of the high frequency signal detected by the detecting section and calculating an interpolated pixel value in the position of the target pixel by a blending process of the plurality of statistics, in an interpolating section.

According to still another embodiment of the present disclosure, there is provided a program which causes a pixel value interpolation process to be executed in an image processing apparatus, the program having a routine including: receiving a color mosaic image generated by an imaging process of a single chip color imaging device as an input and detecting the strength of a high frequency signal in the proximity of a target pixel which is an interpolation process target, in a detecting section; determining a reference region which defines the range of a reference pixel applied for calculating an interpolated pixel value of the target pixel, the reference region having a different area according to the strength of the high frequency signal detected by the detecting section, in a reference region determining section; calculating a statistic for determining the interpolated pixel value on the basis of a pixel value included in the reference region determined by the reference region determining section, in a statistic calculating section; and calculating the interpolated pixel value in the position of the target pixel on the basis of the statistic calculated by the statistic calculating section, in an interpolating section.

Here, the program in this embodiment can be provided, for example, by a storage medium or a communication medium which provides a variety of program codes in a computer-readable format to an image processing apparatus or a computer system which can execute the program codes. As such a program is provided in a computer-readable format, the image processing apparatus or the computer system can realize a process according to the program.

Various objects, features and advantages of the present disclosure will become apparent from detailed description based on embodiments to be described later and accompanying drawings. The term “system” in this description refers to a logic set configuration of a plurality of devices, which is not limited to a configuration in which the respective component devices are disposed in a single casing.

According to the above-described configurations, the color mosaic image generated by the imaging process of the single chip color imaging device is received as an input, and the strength of the high frequency signal in the proximity of the target pixel which is the interpolation process target is detected. Further, the reference region having a different area is set according to the detected strength of the high frequency signal, and the interpolated pixel value is determined using the statistic calculated from the reference region having the different area. For example, in a case where the strength of the high frequency signal is large, the interpolated pixel value in which the contribution of the statistic calculated on the basis of the broad reference region is set at a high level is calculated, and in a case where the strength of the high frequency signal is small, the interpolated pixel value in which the contribution of the statistic calculated on the basis of the narrow reference region is set at a high level is calculated by a blending process. Alternatively, the process is performed using the reference region having an area determined according to the strength of the high frequency signal.

Through these processes, it is possible to set an optimal reference region according to how much a high frequency signal is included in a pixel region, and to generate a high quality image in which false color is suppressed. Hereinafter, a pixel region in which a high frequency signal in the proximity of the Nyquist frequency is included to a large extent in a color signal is referred to as a high frequency region.

### BRIEF DESCRIPTION OF THE DRAWINGS

FIGS. 1A and 1B are diagrams illustrating a demosaicing process;

FIGS. 2A and 2B are diagrams illustrating an example of a mosaic image which is a processing target in an image processing apparatus according to an embodiment of the present disclosure;

FIG. 3 is a diagram illustrating a configuration example of an interpolation executing section of an image processing apparatus according to an embodiment of the present disclosure;

FIG. 4 is a diagram illustrating another configuration example of an interpolation executing section of an image processing apparatus according to an embodiment of the present disclosure; and

FIG. 5 is a diagram illustrating a hardware configuration example of an imaging apparatus which is a configuration example of an image processing apparatus according to an embodiment of the present disclosure.

### DETAILED DESCRIPTION OF EMBODIMENTS

Hereinafter, an image processing apparatus, an image processing method and a program of the present disclosure will be described in detail, with reference to the accompanying drawings. Description will be made in the following order.

1. Outline of process performed by image processing apparatus according to an embodiment

2. Configuration and process of interpolation executing section in image processing apparatus according to the embodiment

3. Hardware configuration example of image processing apparatus according to the embodiment

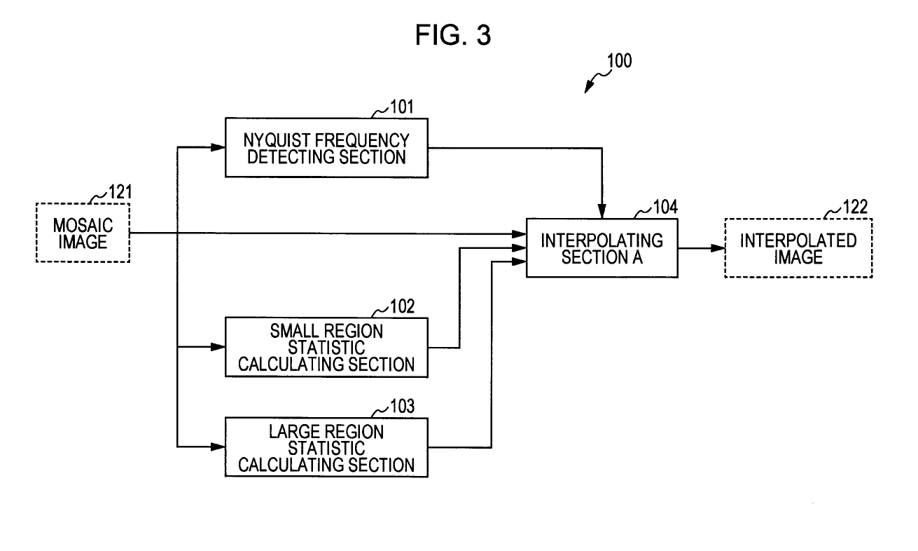

4. Specific processing example of elements of interpolation executing section 100 shown in FIG. 3

(4-1. Process of Nyquist frequency detecting section 101)

(4-2. Process of small region statistic calculating section 102)

(4-3. Process of large region statistic calculating section 103)

(4-4. Process of interpolating section A 104)

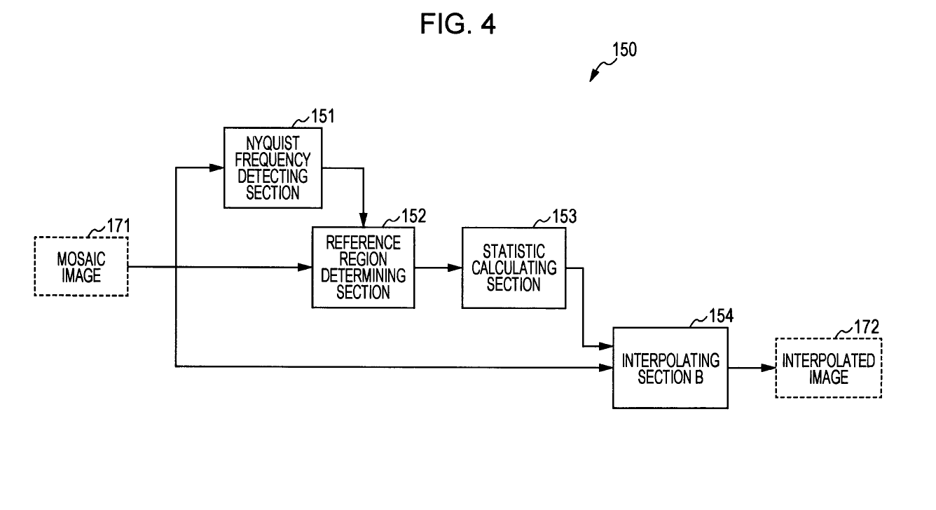

5. Specific processing example of elements of interpolation executing section 150 shown in FIG. 4

(5-1. Process of Nyquist frequency detecting section 151)

(5-2. Process of reference region determining section 152)

(5-3. Process of statistic calculating section 153)

(5-4. Process of interpolating section B 154)

6. Other embodiments

### 1. Outline of Process Performed by Image Executing Apparatus According to an Embodiment

Firstly, an outline of a process performed by an image processing apparatus according to an embodiment will be described.

The image processing apparatus performs an interpolation process of a mosaic image imaged using a single chip color imaging device with high accuracy, and generates a high quality color image.

The present embodiment is a technique capable of being applied to camera signal processing of a digital camera. By using this technique, it is possible to reduce the problem of “false color” in the related art, and to achieve an interpolation result which is visually satisfactory.

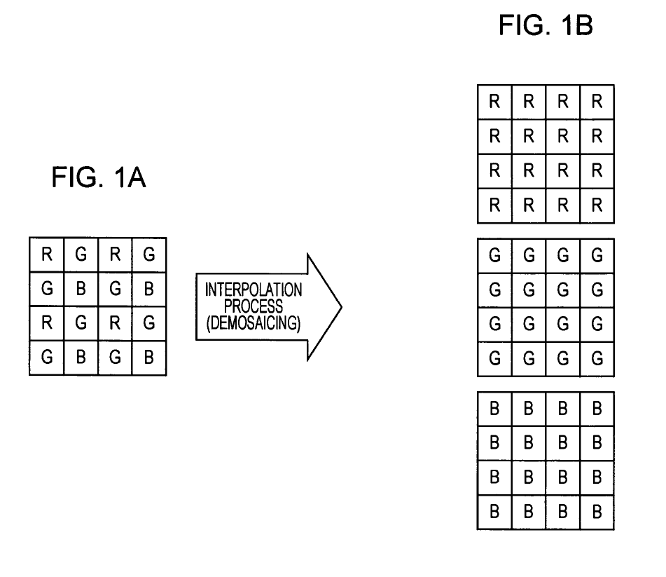

The present embodiment can be applied to an interpolation process for an image imaged by a single chip color imaging device using the Bayer arrangement shown in FIG. 1A, for example, and can be applied to a single chip color imaging device using a color arrangement having a large number of colors.

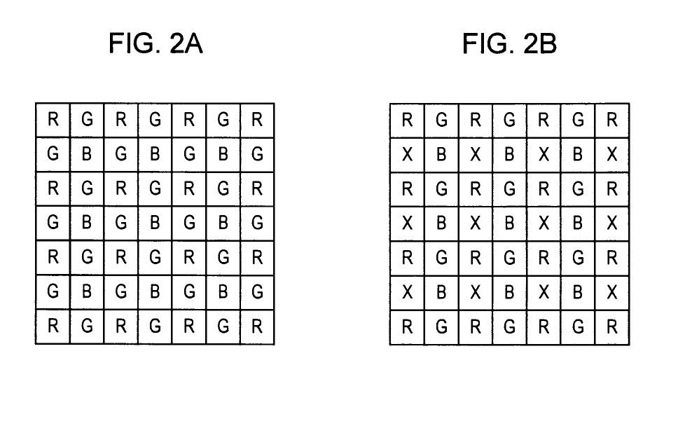

That is, the present embodiment can be applied to an interpolation process for an image imaged by a single chip imaging device having a variety of arrangements, such as a Bayer arrangement (FIG. 2A) or a four-color arrangement (FIG. 2B).

The arrangement shown in FIG. 2A is the Bayer arrangement described with reference to FIG. 1A, and transmits a specific wavelength component color (R, G or B) in the unit of each pixel. The Bayer arrangement is configured by four pixels including two filters which transmit green (G), one filter which transmits blue (B), and one filter which transmits red (R) as a minimum unit.

The arrangement shown in FIG. 2B has an X pixel in addition to R, G and B. For example, X may be set to a variety of colors such as emerald which is different in color from R, G and B, white which transmits all wavelengths, or black which transmits only infrared light.

Further, in addition to imaging devices shown in FIGS. 2A and 2B, the present embodiment can also be applied to an interpolation process for image data obtained by using an imaging device in which four or more colors are arranged.

As the number of colors imaged by the single chip color imaging device increases, the number of pixels per one color decreases and a frequency band where aliasing occurs becomes low. For this reason, an occurrence probability of false color is increased in a single chip color imaging device which images colors exceeding three colors. Thus, it is more effective to use a false color suppressing process according to the present embodiment.

The “aliasing” is noise occurring in a high frequency region of an input signal, which occurs in a high frequency range which is higher than a frequency (Nyquist frequency) which is ½ of a sampling frequency. If the frequency component of the input signal is higher than the Nyquist frequency, the aliasing phenomenon occurs, and a signal derived from a signal of the Nyquist frequency or higher of the frequency component of the input signal is inserted into a frequency component of a signal after sampling as noise.

As the number of colors imaged by the single chip color imaging device is increased, the number of pixels for each color is reduced, and as a result, the sampling frequency is reduced. Consequently, the frequency band where aliasing occurs becomes low.

The present embodiment provides an effective noise reduction solution in the frequency band where such an aliasing phenomenon occurs. Thus, the present embodiment is more effective in a case where the sampling frequency is low and the occurrence probability of false color is high, as in the single chip color imaging device which images the number of colors exceeding three colors.

The false color suppressing process according to the present embodiment can be applied to an interpolation process for an image imaged by a single chip color imaging device which has a variety of arrangements, in addition to the Bayer arrangement or the four-color arrangement shown in FIG. 2A or 2B.

As described above, the image processing apparatus according to the present embodiment provides an effective noise reduction solution in the frequency band where aliasing occurs, to thereby realize an interpolation process with less noise.

The image processing apparatus according to the present embodiment calculates a statistic necessary for the interpolation process using a reference region of an appropriate area according to the strength of aliasing included in a color signal which is imaged by the single chip color imaging device and is output from the imaging device. In a general interpolation process, the interpolation is performed using the fact that a strong correlation is present between different color signals.

For example, an expression of estimating a pixel value of a color C2 using a certain color C1 is represented as the following Expression (1).

$$\begin{matrix}C 1 ( x ) - C 2 ( x ) ≅ \frac{1}{N} {\sum }_{t ∈ local} ( C 1 ( x + t ) - C 2 ( x + t ) ) \\ ≅ m C 1 ( x ) - m C 2 ( x )\end{matrix} \qquad Expression ( 1 )$$

In the Expression (1), x is the position of a target pixel, C1(x) and C2(x) are pixel values of known colors C1 and C2 in the pixel position x, t is an offset of a coordinate indicating a reference region, N is the number of pixels in the reference region, and mC1(x) and mC2(x) are average values of pixel values of C1 and C2 in the reference region including the pixel position x.

In the Expression (1), the pixel value C1(x) of the color C1 in the target pixel position x is directly obtained from an imaging signal, and the pixel value C2(x) of the color C2 in the position x is not directly obtained from the imaging signal. At this time, a difference C1(x)−C2(x) of the color signal in the pixel position x is calculated by the Expression (1), and the pixel value C2(x) of the color C2 in the position x can be calculated according to this expression.

The Expression (1) is an Expression for calculating a pixel value C2(x) of an unknown color C2 in the position x, using the pixel values of the known colors C1 and C2 in the reference region including the position x.

The Expression (1) is an expression for calculating the pixel value (C2(x)) of the color (C2) of the target pixel x which is not able to be directly obtained from an output of the imaging device on the basis of characteristics of a natural picture in which the difference (color difference) of pixel values between different color signals is approximately constantly maintained in a local region.

According to the Expression (1), it is possible to estimate an unclear color signal in the target pixel position using only the known pixel values in the reference region including the target pixel.

For example, if C1(x) is known, the unclear value C2(x) is calculated using C1(x), mC1(x) and mC2(x).

However, in the interpolating method in the Expression (1), when such a high frequency component that causes aliasing is included in a color signal, the term at the center of the Expression (1) and the term at the right end thereof do not coincide with each other, as follows.

$$\frac{1}{N} {\sum }_{t ∈ local} ( C 1 ( x + t ) - C 2 ( x + t ) ) \neq m C 1 ( x ) - m C 2 ( x )$$

That is, there is a problem that such a discrepancy occurs.

Further, the following Expression (2) is obtained by changing the Expression (1).

$$\begin{matrix}C 2 ( x ) ≅ ( C 1 ( x ) - \frac{1}{N} {\sum }_{t ∈ local} C 1 ( x + t ) ) + \\ \frac{1}{N} {\sum }_{t ∈ local} C 2 ( x + t ) \\ ≅ ( C 1 ( x ) - m C 1 ( x ) ) + m C 2 ( x )\end{matrix} \qquad Expression ( 2 )$$

The calculation of the average value of the pixel values is equivalent to application of a low-pass filter (LPF) to the color signal. The Expression (2) shows that the unclear value C2(x) can be calculated by a low frequency component of C2 and a high frequency component of C1.

That is, the interpolation process uses the fact that there is a strong correlation between the high frequency component of C1 and the high frequency component of C2.

In this interpolation process, if the high frequency component is included in the color signal, aliasing occurs, and thus, false color occurs in the interpolation result, in which the calculation result of mC1(x) and mC2(x) deviates from an ideal LPF result.

In the present embodiment, the above problem is solved by changing the area of the reference region used when the statistic (average value in the Expression (1)) is calculated according to frequency characteristics of the color signal.

The reference region corresponds to a setting region of a reference pixel applied for calculation of an interpolated pixel value of the target pixel position.

The color signal in the natural picture predominantly has a low frequency component, and a high frequency component is present in only a part of an object having a sharp edge.

Thus, in most of a region of an image in which a high frequency component is not included in the color signal, it is possible to sufficiently trust the statistic calculated in a narrow reference region without aliasing in the color signal.

Contrarily, in a case where such a high frequency component that causes aliasing in the signal is included in the color signal, if the statistic is calculated using the narrow reference region, it is difficult to calculate a correct statistic by a strong influence of aliasing.

However, since a region in which the high frequency component is present is limited in the natural picture imaged by the imaging apparatus (camera), by enlarging the area in the reference region where the reference pixel value for calculation of the interpolated pixel value is obtained, it is possible to sample the color signal in which only the low frequency component is included as the reference pixel value.

That is, by enlarging the reference region, it is possible to calculate a relatively correct statistic.

In consideration of only the fact that if the reference region is enlarged, the influence of aliasing is reduced, it is preferable to enlarge the reference region as much as possible, but this is not correct.

This is because the correlation relationship between color signals in the target pixel position is maintained in only a narrow region including the target pixel position.

It can be said that the strong correlation between color signals is maintained when the high frequency component of the signal is the center.

Thus, in order to approximate the interpolated value in the interpolation process using the Expression (1) to an ideal pixel value, it is preferable that the reference region for obtaining the reference image value be set to be narrow. For example, in most pixel value interpolation techniques, a predetermined narrow reference region, for example, a region of about 7×7 pixels is used.

In the present embodiment, in addition to the predetermined narrow reference region used in the related art, for example, a broad region of about 31×31 pixels is set as the reference region for obtaining the reference pixel value, and the interpolation process is performed using the reference pixel value in the broad reference region.

If false color occurs in the interpolation process, this seems noticeably unnatural. Thus, false color should be prevented.

Thus, in the present embodiment, the area of the reference region used in the interpolation process is changed according to frequency characteristics of the color signal.

In a case where the high frequency component in the proximity of the Nyquist frequency is included in the color signal, a broad reference region is used, and in a case where the high frequency component in the proximity of the Nyquist frequency is not included in the color signal, a narrow reference region is used.

### 2. Configuration and Process of Interpolation Executing Section in Image Processing Apparatus According to the Embodiment

A configuration and a process of the interpolation executing section in the image processing apparatus according to the present embodiment will be described with reference to FIG. 3 and thereafter.

FIG. 3 is a block diagram illustrating elements of an interpolation executing section 100 which executes the interpolation process in the image processing apparatus according to the present embodiment.

As shown in FIG. 3, the image processing apparatus according to the present embodiment includes a Nyquist frequency detecting section 101, a small region statistic calculating section 102, a large region statistic calculating section 103, and an interpolating section A 104.

A mosaic image 121 which is an output of a single chip imaging device (single chip color imaging device) is input to the interpolation executing section 100. The mosaic image 121 includes only single color data such as R, G or B in each pixel position.

The interpolation executing section 100 outputs an interpolated image 122 in which pixel value data of all colors is set in each pixel position.

The Nyquist frequency detecting section 101 detects the strength of a high frequency signal in the proximity of the Nyquist frequency included in a color signal of the mosaic image 121.

The small region statistic calculating section 102 calculates a statistic using a narrow reference region including a predetermined narrow pixel region.

The large region statistic calculating section 103 calculates a statistic using a broad reference region including a predetermined broad pixel region.

The statistic is a value calculated from the pixel value of the reference region used for determining the interpolated pixel value.

The interpolating section A 104 determines a pixel value of unclear color in a target pixel position which is a pixel position where the interpolated pixel value is determined, firstly using one statistic among the statistics calculated using two different reference regions of the small region statistic calculating section 102 and the large region statistic calculating section 103, according to the strength of the high frequency signal detected in the Nyquist frequency detecting section 101.

Specifically, the interpolating section A 104 performs the following interpolation process.

If it is determined that the high frequency signal detected in the Nyquist frequency detecting section 101 has a strength which is equal to or greater than a predetermined threshold and is in a high frequency region, the interpolation process is performed using the statistic calculated by the large region statistic calculating section 103.

If it is determined that the high frequency signal detected in the Nyquist frequency detecting section 101 has a strength which is smaller than the predetermined threshold and is not in the high frequency region, the interpolation process is performed using the statistic calculated by the small region statistic calculating section 102. Further, instead of the simple switching through the threshold, two statistics may be blended according to the strength of the high frequency signal.

The interpolation executing section 100 shown in FIG. 3 calculates two different statistics using two reference regions having different sizes for the small region statistic calculating section 102 and the large region statistic calculating section 103. Alternatively, as a configuration capable of using three or more reference regions having different sizes, the interpolation executing section 100 may calculate three or more statistics, which may be selectively applied according to the strength of the high frequency signal detected in the Nyquist frequency detecting section 101.

For example, the following interpolation process is performed in a case where three statistic calculating sections of a small region statistic calculating section which calculates a statistic using a narrow reference region, an intermediate region statistic calculating section which calculates a statistic using an intermediate reference region, and a large region statistic calculating section which calculates a statistic using a broad reference region are set.

The interpolating section A 104 performs the following interpolation process.

The following interpolation process is performed according to the strength S of the high frequency signal detected in the Nyquist frequency detecting section 101.

When threshold Th1≦S, the interpolation process is performed using the statistic calculated by the large region statistic calculating section which calculates the statistic using the broad reference region.

When threshold Th2≦S<threshold Th1, the interpolation process is performed using the statistic calculated by the intermediate region statistic calculating section which calculates the statistic using the intermediate reference region.

When S<threshold Th2, the interpolation process is performed using the statistic calculated by the small region statistic calculating section which calculates the statistic using the narrow reference region.

In this way, it is possible to use the configuration having three or more different reference regions.

FIG. 4 illustrates an interpolation executing section 150 in an image processing apparatus according to a second embodiment.

The interpolation executing section 150 shown in FIG. 4 includes a Nyquist frequency detecting section 151, a reference region determining section 152, a statistic calculating section 153, and an interpolating section B 154.

A mosaic image 171 which is an output of a single chip imaging device (single chip color imaging device) is input to the interpolation executing section 150. The mosaic image 171 includes only single color data such as R, G or B in each pixel position.

The interpolation executing section 150 outputs an interpolated image 172 in which pixel value data of all colors is set in each pixel position.

The Nyquist frequency detecting section 151 detects the strength of a high frequency signal in the proximity of the Nyquist frequency included in a color signal of the mosaic image 171.

The reference region determining section 152 determines the size of the reference region according to the strength of the high frequency signal detected in the Nyquist frequency detecting section 101.

Specifically, the reference region determining section 152 performs the following reference region determining process.

If it is determined that the strength of the high frequency signal detected in the Nyquist frequency detecting section 151 is stronger than a preset threshold, for example, and corresponds to a high frequency region, the size of the reference region is enlarged.

Further, if it is determined that the strength of the high frequency signal detected in the Nyquist frequency detecting section 151 is weaker than the preset threshold, for example, and does not correspond to the high frequency region, the size of the reference region is reduced.

The statistic calculating section 153 uses a pixel value in the reference region determined by the reference region determining section 152 as a reference pixel to calculate the statistic.

The interpolating section B 154 performs an interpolation process of determining a pixel value of unclear color on the basis of the statistic calculated by the statistic calculating section 153.

In this way, in the image processing apparatus according to the present embodiment, the area of the reference region is changed, the statistic is calculated using a broad reference pixel region in the high frequency region and using a narrow reference pixel region in a region which is not the high frequency region, and the interpolation pixel value is determined using the calculated statistic.

By performing this process, it is possible to suppress false color in a pixel region where false color is generated in the related art, and to achieve interpolation performance in other regions at the same level as in the related art.

It can be said that the present disclosure relates to the image processing apparatus which achieves balance by changing the area of the reference region with respect to different image quality issues of false color suppression and interpolation performance maintenance.

The strength of the high frequency signal is calculated by applying a high-pass filter to the color signal, but in a case where the number of pixels of a certain color is different from the number of pixels of a different color, the high-pass filter is applied to the color having a large number of pixels, and the result may be used for the color having a small number of pixels.

The reason is as follows. That is, since a strong correlation is present between colors in the natural picture imaged by the imaging apparatus (camera), it is possible to use the strength of the high frequency signal of a certain color as a substitute for the strength of the high frequency component of a different color, and it is possible to detect the high frequency signal with high accuracy so that the degree of freedom in design of the high-pass filter is enhanced in the large number of pixels.

In a case where the interpolation executing section in the present embodiment is realized as hardware, it is possible to reduce the cost of the hardware by using an IIR (infinite impulse response) filter in calculation of statistics in the broad reference region.

The IIR filter is an anisotropy filter, but since performance deterioration of the interpolation process caused by anisotropy is barely perceived in a visual sense, this does not cause a problem.

### 3. Hardware Configuration Example of Image Processing Apparatus According to the Present Embodiment

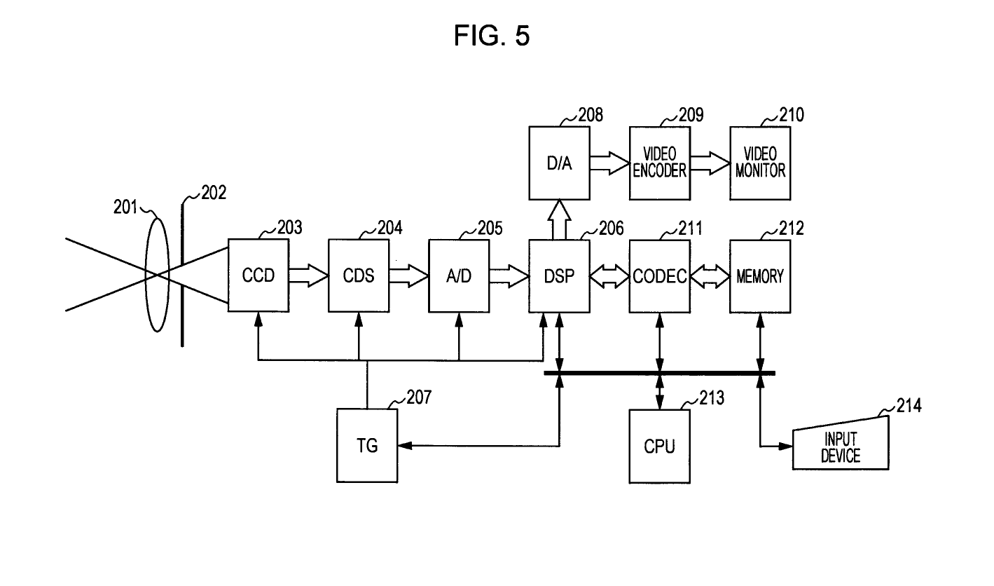

Next, a configuration example of an image processing apparatus (digital still camera) according to the present embodiment will be described with reference to FIG. 5. A configuration and an operation of the entire image will be firstly described, and then configurations and operation of the respective sections will be described. Finally, variations which can be derived from the present embodiment will be described.

FIG. 5 is a block diagram illustrating a configuration of a digital still camera system which is an example of the image processing apparatus according to the present embodiment. As shown in FIG. 5, the image processing apparatus includes a lens 201, an aperture 202, a CCD image sensor 203, a correlation double sampling circuit 204, an A/D converter 205, a DSP block 206, a timing generator 207, a D/A converter 208, a video encoder 209, a video monitor 210, a CODEC 211, a memory 212, a CPU 213, and an input device 214.

The input device 214 is an operation button or the like such as a recording button disposed in a camera body. Further, the DSP block 206 is a block which has a signal processor and an image RAM, in which the signal processor can perform image processing programmed in advance for image data stored in the image RAM. Hereinafter, the DSP block is simply referred to as a DSP.

Incident light which has reached the CCD 203 through an optical system reaches each light receiving device on a CCD imaging surface, is converted into an electric signal by photoelectric conversion in the light receiving device, undergoes noise-removal by the correlation double sampling circuit 204, is digitized by the A/D converter 205, and then is temporarily stored in an image memory of the DSP 206.

During imaging, the timing generator 207 controls a signal processing system so that image importing is maintained at a predetermined frame rate. A pixel stream is transmitted to the DSP 206 at a predetermined rate, appropriate image processing is performed, and then the image data is transmitted to the D/A converter 208 or the CODEC 211, or both of them. The D/A converter 208 converts the image data transmitted from the DSP 206 into an analog signal, and the video encoder 209 converts the result into a video signal. The video monitor 210 can monitor the video signal, which serves as a camera finder in the present embodiment. Further, the CODEC 211 performs encoding for the image data transmitted from the DSP 206, and the encoded image data is recorded in the memory 212. Here, the memory 212 may be a recording device or the like which uses a semiconductor, a magnetic recording medium, a magneto-optical medium, an optical recording medium or the like.

Hereinbefore, the entire system of the digital video still camera in the present embodiment has been described, but the interpolation process or the like which is the image processing relating to the present disclosure is performed in the DSP 206. The interpolation executing section described with reference to FIGS. 3 and 4 is included in the DSP 206 in the image processing apparatus which is the digital still camera shown in FIG. 5.

Hereinafter, a processing example performed in the DSP 206 of the image processing apparatus which is the digital still camera shown in FIG. 5 according to the present embodiment will be described.

In the DSP 206, a calculation unit sequentially executes calculation described in a predetermined program code for an input image signal stream. Hereinafter, each processing unit in the program is described as a functional block, and an each processing execution order is described as a flowchart. However, in the present disclosure, a hardware circuit which realizes the same process as the functional block described hereinafter may be mounted, instead of the program described in the present embodiment.

### 4. Specific Processing Example of Elements of Interpolation Executing Section 100 Shown in FIG. 3

Firstly, in the interpolation executing section of the image processing apparatus according to the present embodiment as described with reference to FIGS. 3 and 4, the area of the reference region is changed, the statistic is calculated using the broad reference pixel region in the high frequency region, and using the narrow reference pixel region in the region which is not the high frequency region, and the interpolated pixel value is determined using the calculated statistic.

By performing the above-described process, it is possible to suppress false color in a pixel region where false color is generated in the related art, and to achieve interpolation performance in other regions at the same level as in the related art.

Hereinafter, in the interpolation executing section 100 shown in FIG. 3, a specific processing example will be described in a case where a mosaic image 121 which is an output of a single chip imaging device (single chip color imaging device) having a four color arrangement of R, G, B and X, as shown in FIG. 2B, is input.

(4-1. Process of Nyquist Frequency Detecting Section 101)

Firstly, a process of the Nyquist frequency detecting section 101 will be described.

In the Nyquist frequency detecting section 101, a signal of a different color Y which is larger in the number of pixels than four colors (R, G, B and X) included in FIG. 2B and has a higher frequency component is calculated using the following Expression (3). Y represents a signal of a different color which is larger in the number of pixels than four colors (R, G, B and X) directly obtained from a single chip imaging device (single chip color imaging device) and has a higher frequency component.

Y(x+0.5,y+0.5)≅Mosaic(x,y)+Mosaic(x+1,y)+Mosaic(x,y+1)+Mosaic(x+1,y+1) Expression (3)

In the above Expression (3), x and y represent pixel positions, and “Mosaic” represents a mosaic image.

The Y signal is calculated as a pixel value in the central position of 4 pixels of R, G, B and X.

The Nyquist frequency detecting section 101 subsequently calculates the strength of a high frequency component of Y according to the following Expression (4), using a high-pass filter (HPF) which transmits a frequency band in the proximity of the Nyquist frequency of color components of R, G, B and X.

$$Nyq ( x , y ) = {\sum }_{t = 0}^{1} {\sum }_{s = 0}^{1} \vert \begin{matrix}\begin{matrix}Y ( x + s - 1.5 , y + t - 0.5 ) - \\ Y ( x + s - 0.5 , y + t - 0.5 ) \times 2 +\end{matrix} \\ Y ( x + s + 0.5 , y + t - 0.5 )\end{matrix} \vert + \vert \begin{matrix}\begin{matrix}Y ( x + s - 0.5 , y + t - 1.5 ) - \\ Y ( x + s - 0.5 , y + t - 0.5 ) \times 2 +\end{matrix} \\ Y ( x + s - 0.5 , y + t + 0.5 )\end{matrix} \vert \qquad Expression ( 4 )$$

In the above expression, Nyq(x,y) is a value indicating the strength of a high frequency component in a target pixel (x,y). The above expression is an expression which calculates the strength of the high frequency component on the basis of distribution of the Y signal in the proximity of the target pixel (x,y).

The value Nyq(x,y) calculated according to this expression is supplied to the interpolating section A 104 shown in FIG. 3 as a strength index value of the high frequency component in the target pixel (x,y).

The interpolating section A 104 determines which one of the statistics calculated in two different reference regions is preferentially used, on the basis of this value.

That is, as described above, the interpolating section A 104 performs the following interpolation process.

When the Nyq(x,y) calculated in the Nyquist frequency detecting section 101 is large, the interpolation process is performed preferentially using the statistic calculated by the large region statistic calculating section 103.

When the Nyq(x,y) calculated in the Nyquist frequency detecting section 101 is small, the interpolation process is performed preferentially using the statistic calculated by the small region statistic calculating section 102.

(4-2. Process of Small Region Statistic Calculating Section 102)

Next, a process of the small region statistic calculating section 102 will be described.

The small region statistic calculating section 102 sets a narrow pixel region where the target pixel (x,y) which is an interpolation target pixel is the center, for example, a partial region of 7×7 pixels as a reference region, and calculates average values of pixel values of R, G, B, X and Y included in the narrow reference region as statistics applied for determining interpolated pixel values.

Hereinafter, the average values of the respective colors of R, G, B, X and Y in the narrow region (for example, 7×7 pixel region) calculated in the small region statistic calculating section 102 are expressed as follows.

Average value of R: mHR(x,y)

Average value of G: mHG(x,y)

Average value of B: mHB(x,y)

Average value of X: mHX(x,y)

Average value of Y: mHY(x,y)

The small region statistic calculating section 102 calculates these values as statistics in the narrow reference region (for example, 7×7 pixel region).

(4-3. Process of Large Region Statistic Calculating Section 103)

Next, a process of the large region statistic calculating section 103 will be described.

The large region statistic calculating section 103 sets a broad pixel region where the target pixel (x,y) which is an interpolation target pixel is the center, for example, a partial region of 31×31 pixels as a reference region, and calculates average values of pixel values of R, G, B, X and Y included in the broad reference region as statistics applied for determining interpolated pixel values.

Hereinafter, the average values of the respective colors of R, G, B, X and Y in the broad region (for example, 31×31 pixel region) calculated in the large region statistic calculating section 103 are expressed as follows.

Average value of R: mLR(x,y)

Average value of G: mLG(x,y)

Average value of B: mLB(x,y)

Average value of X: mLX(x,y)

Average value of Y: mLY(x,y)

The large region statistic calculating section 103 calculates these values as statistics in the broad reference region (for example, 31×31 pixel region).

(4-4. Process of Interpolating Section A 104)

Next, a process of the interpolating section A 104 will be described.

In the interpolating section A 104, an interpolated pixel value in the target pixel (x,y) which is the interpolation target pixel position, that is, a pixel value of unclear color is determined according to the following Expression (5).

Blend(x,y)=min(Nyq(x,y)×const1,1)

C(x,y)=Y(x,y)−(m_{L}Y(x,y)×Blend(x,y)+m_{H}Y(x,y)×(1−Blend(x,y)))+(m_{L}C(x,y)×Blend(x,y)+m_{H}C(x,y)×(1−Blend(x,y))) Expression (5)

In the above Expression (5), “const1” is a coefficient for controlling a blending ratio of statistics calculated in two different reference regions.

By changing the coefficient, it is possible to control the false color suppression effect. Further, C in the Expression is replaced with any color of R, G, B and X.

The Expression (5) is an expression which calculates an interpolated pixel value C(x,y) of a final target pixel by blending respective average values, that is, average values of a Y signal and a C signal (color signal where any one of R, G, B and X is an interpolation target) in the narrow reference region (for example, 7×7 pixel region) calculated in the small region statistic calculating section 102, that is, the average value of Y: mHY(x,y) and the average value of C: mHC(x,y); and average values of a Y signal and a C signal (color signal where any one of R, G, B and X is an interpolation target) in the broad reference region (for example, 31×31 pixel region) calculated in the large region statistic calculating section 103, that is, the average value of Y: mLY(x,y) and the average value of C: mLC(x,y).

The blending ratio Blend(x,y) is calculated according to the Expression Blend(x,y)=min(Nyq(x,y)×const1, 1).

That is, a value (Nyq(x,y)×const1) obtained by multiplying the strength index value Nyq(x,y) of the high frequency component in the target pixel (x,y) calculated according to the above-described Expression (4) by the predetermined coefficient “const1” is compared with 1 to select a smaller value, and the selected value is set to the blending ratio Blend(x,y).

For example, in the high frequency region, the value of (Nyq(x,y)×const1) is increased, and thus (Nyq(x,y)×const1)>1. In this case, the blending ratio Blend(x,y) calculated according to the above Expression Blend(x,y)=min(Nyq(x,y)×const1, 1) becomes Blend(x,y)=1.

In such a high frequency region, the interpolated pixel value C(x,y) of the target pixel calculated according to the above Expression (5) is calculated by only the average values of the Y signal and the C signal (color signal where any one of R, G, B and X is an interpolation target) in the broad reference region (for example, 31×31 pixel region), that is, the average value of Y: mLY(x,y) and the average value of C: mLC(x,y).

On the other hand, in a region where the high frequency component is small, the value of (Nyq(x,y)×const1) is reduced, and thus, (Nyq(x,y)×const1)<1. In this case, the blending ratio Blend(x,y) calculated according to the above Expression Blend(x,y)=min(Nyq(x,y)×const1, 1) becomes Blend(x,y)=0 to 1.

In a flat region where such a high frequency component is small, the interpolated pixel value C(x,y) of the target pixel calculated according to the above Expression (5) has a contribution, which is larger than zero, of the average values of the Y signal and the C signal (color signal where any one of R, G, B and X is an interpolation target) in the narrow reference region (for example, 7×7 pixel region), that is, the average value of Y: mHY(x,y) and the average value of C: mHC(x,y).

As the value of (Nyq(x,y)×const1) is reduced, that is, as the high frequency component becomes smaller, the contribution of the average values of the Y signal and the C signal (color signal where any one of R, G, B and X is an interpolation target) in the narrow reference region (for example, 7×7 pixel region), that is, the average value of Y: mHY(x,y) and the average value of C: mHC(x,y), is increased.

At this time, the contribution of the average values of the Y signal and the C signal (color signal where any one of R, G, B and X is an interpolation target) in the broad reference region (for example, 31×31 pixel region), that is, the average value of Y: mLY(x,y) and the average value of C: mLC(x,y), is decreased.

In this way, in the high frequency region, the interpolated pixel value C(x,y) of the final target pixel is set so that the contribution of the statistics (average values) in the broad reference region (for example, 31×31 pixel region) calculated by the large region statistic calculating section 103 is high and the contribution of the statistics (average values) in the narrow reference region (for example, 7×7 pixel region) is low.

On the other hand, in the flat region where the high frequency component is small, the interpolated pixel value C(x,y) of the final target pixel is set so that the contribution of the statistics (average values) in the broad reference region (for example, 31×31 pixel region) calculated by the large region statistic calculating section 103 is low and the contribution of the statistics (average values) in the narrow reference region (for example, 7×7 pixel region) is high.

The interpolation executing section 100 shown in FIG. 3 receives as an input the mosaic image 121 which is the output of the single chip imaging device (single chip color imaging device) through this process, and outputs an interpolated image 122 by performing the interpolation process of setting the pixel values of all colors (R, G, B and X) in each pixel position.

### 5. Specific Processing Example of Elements of Interpolation Executing Section 150 Shown in FIG. 4

Next, a specific processing example in a case where the mosaic image 121 which is the output of the single chip imaging device (single chip color imaging device) having the four color arrangement of R, G, B and X shown in FIG. 2B is input in the interpolation executing section 150 shown in FIG. 4, will be described.

(5-1. Process of Nyquist Frequency Detecting Section 151)

Firstly, a process of the Nyquist frequency detecting section 151 will be described.

The process of the Nyquist frequency detecting section 151 is performed in the same way as the process of the Nyquist frequency detecting section 101 shown in FIG. 3.

Firstly, a signal value of a different color which is larger in the number of pixels than four colors (R, G, B and X) included in FIG. 2B and has a higher frequency component is calculated using the following Expression (3).

Next, the strength of a high frequency component of Y is calculated according to the Expression (4), using a high-pass filter (HPF) which transmits a frequency band in the proximity of the Nyquist frequency of color components of R, G, B and X.

The value NYq(x,y) calculated according to the Expression (4) is supplied to the reference region determining section 152 shown in FIG. 4 as a strength index value of the high frequency component in the target pixel (x,y).

The reference region determining section 152 determines the area of the reference region according to this value.

(5-2. Process of Reference Region Determining Section 152)

Next, a process of the reference region determining section 152 will be described.

The reference region determining section 152 sets a reference region where the target pixel position is the center, according to the strength of the high frequency component of the color signal detected in the Nyquist frequency detecting section 151.

Specifically, as described above, the reference region determining section 152 performs the following reference region determining process.

If it is determined that the strength of the high frequency signal detected in the Nyquist frequency detecting section 151 is stronger than a preset threshold, for example, and corresponds to a high frequency region, the size of the reference region is enlarged.

Further, if it is determined that the strength of the high frequency signal detected in the Nyquist frequency detecting section 151 is weaker than the preset threshold, for example, and does not correspond to the high frequency region, the size of the reference region is reduced.

For example, the reference region is selected in a range of 7×7 pixels to 31×31 pixels, for example.

Specifically, the reference region determining section 152 sets a broad reference region when the strength of the high frequency component is strong according to the following Expression (6), for example.

if (Nyq(x,y)<const2), then set reference region as 7×7 pixels

if (const2≦Nyq(x,y)<const3), then set reference region as 9×9 pixels

if (const3≦Nyq(x,y)<const4), then set reference region as 11×11 pixels

if (const13≦Nyq(x,y)), then set reference region as 31×31 pixels Expression (6)

In the Expression (6), const2 to const13 are coefficients which are preset for controlling the false color suppression effect, in which const2<const3<const4< . . . <const13.

Information about the reference region determined by the reference region determining section 152 is supplied to the statistic calculating section 153.

(5-3. Process of Statistic Calculating Section 153)

Next, a process of the statistic calculating section 153 will be described.

The statistic calculating section 153 calculates average values of pixel values which are statistics used for determining interpolated pixel values, using R, G, B, X and Y included in the reference region range selected by the reference region determining section 152 as reference pixels.

Hereinafter, the average values of the respective colors of R, G, B, X and Y calculated on the basis of the reference pixels in the reference region in the statistic calculating section 153 are expressed as follows.

Average value of R: mR(x,y)

Average value of G: mG(x,y)

Average value of B: mB(x,y)

Average value of X: mX(x,y)

Average value of Y: mR(x,y)

The statistic calculating section 153 calculates these values, using R, G, B, X and Y included in the reference region range selected by the reference region determining section 152 as reference pixels.

(5-4. Process of Interpolating Section B 154)

Next, the process of the interpolating section B 154 will be described.

The interpolation processing section B 154 determines a pixel value of unclear color in the target pixel position (x,y) which is the pixel position of the interpolation process, according to the following Expression (7).

C(x,y)=(Y(x,y)−mY(x,y))+mC(x,y) (7)

In the Expression (7), C is replaced with any color of R, G, B, and X.

The interpolation executing section 150 shown in FIG. 4 receives as an input the mosaic image 171 which is the output of the single chip imaging device (single chip color imaging device) through this process, and outputs an interpolated image 172 by performing the interpolation process of setting the pixel values of all colors (R, G, B and X) in each pixel position.

### 6. Other Embodiments

The 7×7 pixel region which is the narrow reference region and the 31×31 pixel region which is the broad reference region according to the above embodiments are described above as examples.

The sizes of the reference regions may be appropriately selected according to the number of pixels of the mosaic image or the number of included colors.

The present disclosure can be applied to a variety of color arrangements. For example, with respect to the Bayer arrangement shown in FIG. 2A generally used in a digital camera, a configuration may be employed in which G is interpolated in all the pixel positions in the related technique and a different color is then interpolated using a G signal instead of a Y signal used in the above embodiments.

In the above-described embodiments, when the Y signal is calculated in all the pixel positions, R, G, B and X obtained from the output of the single chip imaging device (single chip color imaging device) are added and averaged according to the above-described Expression (3), but the Y signal may be calculated using a complicated method in consideration of the contribution or the like for the Y signal of each pixel value.

Further, in the above-described embodiments, an example is described in which the average values are used as the statistics used for calculating the interpolated pixel values and simple averages of the pixel values in the reference region are obtained in calculation of the average values, but a configuration may be employed in which a weight according to the pixel position is set to obtain a weighted average.

The weight is set to be small as the pixel position in the reference region is distant from the position of the target pixel.

The calculation of the average values can be performed as a process which mainly uses a low-pass filter (LPF), and corresponds to a process of changing a coefficient of the LPF filter according to the pixel position. Compared with an LPF (simple average) having a coefficient of 1 in all the pixel positions, an LPF having a coefficient which becomes small as the pixel position is distant from the target pixel position has no rapid change in frequency characteristics and assumes a satisfactory interpolation result.

As the statistics for determining the interpolated pixel values, data such as variance or covariance may be used, instead of the average values of the pixels in the reference region.

As an expression for estimating a pixel value of unclear color in an interpolated pixel position, the above-described Expression (2) is employed, but the estimation expression of the interpolated pixel value is not limited to the Expression (2).

For example, the above-described Expression (2) can be expressed as in the following Expression (8) if it is expressed as a general expression.

C2(x)≅k(C1(x)−mC1(x))+mC2(x) Expression (8)

The above-described Expression (2) corresponds to a case where the coefficient k is set as k=1 in a linear regression expression expressed in the Expression (8).

Here, as a calculation method of the coefficient k, there is a method or the like which employs the following Expression (9) or (10).

$$\begin{matrix}k = \frac{mC 2 ( x )}{m C 1 ( x )} & Expression ( 9 ) \\ k = \frac{\begin{matrix}\frac{1}{N} {\sum }_{t ∈ local} ( C 1 ( x + t ) \times C 2 ( x + t ) ) - \\ ( \frac{1}{N} {\sum }_{t ∈ local} C 1 ( x + t ) ) ( \frac{1}{N} {\sum }_{t ∈ local} C 2 ( x + t ) )\end{matrix}}{\begin{matrix}\frac{1}{N} {\sum }_{t ∈ local} {( C 1 ( x + t ) )}^{2} - \\ {( \frac{1}{N} {\sum }_{t ∈ local} C 1 ( x + t ) )}^{2}\end{matrix}} & Expression ( 10 )\end{matrix}$$

Here, the coefficient k is calculated according to the Expression (9) or (10), for example. A calculation method which is advantageous in view of mounting is selected from these calculation methods, according to a trade-off between the interpolation performance and the calculation amount, for example.

For example, the Expression (10) is an expression with high interpolation performance in consideration of both of a positive correlation and a negative correlation between signals, but it is necessary that all colors are present in all pixel positions for application to a color mosaic image. Accordingly, since color signal interpolation should be performed in advance with high accuracy for calculation of k, and the expression itself is complicated, this causes a high burden in calculation.

Further, when statistics such as averages in the reference regions applied for determining the interpolated pixel values are calculated, it is possible to reduce the cost in installation of hardware using the IIR (infinite impulse response) filter.

In a case where the circuit for performing calculation of statistics is mounted as hardware on the digital camera, a kind of memory called a delay line in the related art is used. The memory is hardware having a large scale as a hardware scale, and a delay line having a large circuit scale should be provided for calculation of statistics on the basis of pixel values in the broad reference region.

When an isotropic region (region having the same width in vertical and horizontal directions, with reference to the target pixel position) is used as the reference region, a very large delay line should be provided. However, when an anisotropic region is used as the reference region, it is possible to perform the statistic calculation using the IIR.

For example, in order to calculate average values of pixel values which are input in the order of raster scanning using the IIR, an X-directional one-dimensional accumulation buffer is prepared for each color, and pixel values may be sequentially accumulated and averaged according to the following Expression (11).

AccumulationBuffer_{C}(x(T),T)=AccumulationBufferC(x(T),T−1)×const14+C(x(T))×(1−const14) Expression (11)

In the Expression (11), x represents an x-directional coordinate position, T represents time, and const14 represents a coefficient of an IIR filter in the range of [0:1].

Here, C is replaced with a color included in a color arrangement.

Hereinbefore, the present disclosure has been described with reference to specific embodiments. However, it is obvious that those skilled in the art can make modifications or substitutes of the embodiments in a range without departing from the spirit of the present disclosure. That is, the embodiments of the present disclosure are exemplary, and thus should not be interpreted as being limitative. In order to determine the spirit of the present disclosure, claims should be considered.

Further, the series of processes described in the present disclosure can be performed by hardware, software or a composite configuration thereof. In a case where the processes are performed by software, a program in which a process sequence is recorded can be installed in a memory in a computer assembled in exclusive hardware to be executed, or a program can be installed in a general-purpose computer capable of performing a variety of processes to be executed. For example, it is possible to store the program in a recording medium in advance. In addition to the installation in the computer from the recording medium, it is possible to receive the program through a network such as a LAN (Local Area Network) or the Internet and to install the program in a recording medium such as a built-in hard disk.

The variety of processes disclosed in this specification may be performed in a time series manner according to circumstances, or may be performed in parallel or individually according to the processing capability of the apparatus which performs the processes or as necessary. Further, the term “system” in this specification refers to a logic set configuration of a plurality of devices, which is not limited to a configuration in which the respective component devices are disposed in the same casing.

The present disclosure contains subject matter related to that disclosed in Japanese Priority Patent Application JP 2010-236176 filed in the Japan Patent Office on Oct. 21, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a detecting section which receives a color mosaic image generated by an imaging process of a single chip color imaging device as an input and detects the strength of a high frequency signal in the proximity of a target pixel which is an interpolation process target;
a plurality of statistic calculating sections each of which sets a reference region having a different area around the target pixel and calculates an individual statistic based on a pixel value included in the reference region; and
an interpolating section which changes a blended state of the plurality of statistics calculated by the plurality of statistic calculating sections according to the strength of the high frequency signal detected by the detecting section and calculates an interpolated pixel value in the position of the target pixel by a blending process of the plurality of statistics.

2. The apparatus according to claim 1,
wherein the interpolating section calculates the interpolated pixel value in which a contribution of a statistic calculated on the basis of a broad reference region is set at a high level in a case where the strength of the high frequency signal detected by the detecting section is large, and calculates the interpolated pixel value in which a contribution of a statistic calculated on the basis of a narrow reference region is set at a high level in a case where the strength of the high frequency signal detected by the detecting section is small.

3. An image processing apparatus comprising:
a detecting section which receives a color mosaic image generated by an imaging process of a single chip color imaging device as an input and detects the strength of a high frequency signal in the proximity of a target pixel which is an interpolation process target;
a reference region determining section which determines a reference region which defines the range of a reference pixel applied for calculating an interpolated pixel value of the target pixel, the reference region having a different area according to the strength of the high frequency signal detected by the detecting section;
a statistic calculating section which calculates a statistic for determining the interpolated pixel value on the basis of a pixel value included in the reference region determined by the reference region determining section; and
an interpolating section which calculates the interpolated pixel value in the position of the target pixel on the basis of the statistic calculated by the statistic calculating section.

4. The apparatus according to claim 3,
wherein the reference region determining section sets a broad reference region in a case where the strength of the high frequency signal detected by the detecting section is large, and sets a narrow reference region in a case where the strength of the high frequency signal detected by the detecting section is small.

5. The apparatus according to claim 1,
wherein the detecting section detects the strength of the high frequency signal in the proximity of a Nyquist frequency, in the proximity of the target pixel which is the interpolation process target.

6. The apparatus according to claim 5,
wherein the detecting section detects the strength of the high frequency signal using a high-pass filter (HPF) which transmits a high frequency band in the proximity of the Nyquist frequency.

7. The apparatus according to claim 1,
wherein the detecting section calculates a color signal included in the color mosaic image generated by the imaging process of the single chip color imaging device and detects the strength of the high frequency signal on the basis of the calculated signal.

8. The apparatus according to claim 1,
wherein the statistic calculating section calculates an average of the pixel values of pixels included in the reference region as the statistic.

9. The apparatus according to claim 1,
wherein the statistic calculating section employs an IIR (Infinite Impulse Response) filter.

10. An image processing method of performing a pixel value interpolation process in an image processing apparatus, the method comprising:
receiving a color mosaic image generated by an imaging process of a single chip color imaging device as an input and detecting the strength of a high frequency signal in the proximity of a target pixel which is an interpolation process target, by a detecting section;
setting a reference region having a different area around the target pixel and calculating an individual statistic based on a pixel value included in the reference region, by each of a plurality of statistic calculating sections; and
changing a blended state of the plurality of statistics calculated by the plurality of statistic calculating sections according to the strength of the high frequency signal detected by the detecting section and calculating an interpolated pixel value in the position of the target pixel by a blending process of the plurality of statistics, by an interpolating section.

11. An image processing method of performing a pixel value interpolation process in an image processing apparatus, the method comprising:
receiving a color mosaic image generated by an imaging process of a single chip color imaging device as an input and detecting the strength of a high frequency signal in the proximity of a target pixel which is an interpolation process target, by a detecting section;
determining a reference region which defines the range of a reference pixel applied for calculating an interpolated pixel value of the target pixel, the reference region having a different area according to the strength of the high frequency signal detected by the detecting section, by a reference region determining section;
calculating a statistic for determining the interpolated pixel value on the basis of a pixel value included in the reference region determined by the reference region determining section, by a statistic calculating section; and
calculating the interpolated pixel value in the position of the target pixel on the basis of the statistic calculated by the statistic calculating section, by an interpolating section.

12. A program which causes a pixel value interpolation process to be executed in an image processing apparatus, the program having a routine comprising:
receiving a color mosaic image generated by an imaging process of a single chip color imaging device as an input and detecting the strength of a high frequency signal in the proximity of a target pixel which is an interpolation process target, in a detecting section;
setting a reference region having a different area around the target pixel and calculating an individual statistic based on a pixel value included in the reference region, in each of a plurality of statistic calculating sections; and
changing a blended state of the plurality of statistics calculated by the plurality of statistic calculating sections according to the strength of the high frequency signal detected by the detecting section and calculating an interpolated pixel value in the position of the target pixel by a blending process of the plurality of statistics, in an interpolating section.

13. A program which causes a pixel value interpolation process to be executed in an image processing apparatus, the program having a routine comprising:
receiving a color mosaic image generated by an imaging process of a single chip color imaging device as an input and detecting the strength of a high frequency signal in the proximity of a target pixel which is an interpolation process target, in a detecting section;
determining a reference region which defines the range of a reference pixel applied for calculating an interpolated pixel value of the target pixel, the reference region having a different area according to the strength of the high frequency signal detected by the detecting section, in a reference region determining section;
calculating a statistic for determining the interpolated pixel value on the basis of a pixel value included in the reference region determined by the reference region determining section, in a statistic calculating section; and
calculating the interpolated pixel value in the position of the target pixel on the basis of the statistic calculated by the statistic calculating section, in an interpolating section.
